(19) United States
(12) Patent Application Publication
(10) Pub. No.: US 2003/0193581 A1
(43) Pub. Date: Oct. 16, 2003

(54) Electronic camera capable of recording thumbnail pictures

(75) Inventor: Akira Miyata, Tokyo (JP)

Correspondence Address: HOGAN & HARTSON L.L.P., 500 S. GRAND AVENUE, SUITE 1900, LOS ANGELES, CA, 90071-2611, US

(73) Assignee: CASIO COMPUTER CO., LTD

(21) Appl. No.: 10/406,082

(22) Filed: Apr. 2, 2003

(30) Foreign Application Priority Data
Apr. 12, 2002 (JP) 2002-110756
Feb. 26, 2003 (JP) 2003-049247

(51) Int. Cl. H04N 5/76

(52) U.S. Cl. 348/231.3

(57) ABSTRACT

A picture recording apparatus is equipped with a photographing unit that photographs subjects, a memory that stores picture data files and a control unit. The control unit controls various functional units that create preview picture data based on main picture data by reducing the number of pixels of the main picture data, create thumbnail picture data having a predetermined number of pixels, create a picture data file that may include the main picture data and the corresponding preview picture data and thumbnail picture data, and store the picture data file in the memory. The control unit includes a judging unit that judges, upon selecting one of the picture data files stored in the memory in a playing mode, as to whether the selected picture data file includes preview picture data. When the selected picture data file does not include preview picture data, main picture data or thumbnail picture data in the selected picture data file is displayed.

### BACKGROUND OF THE INVENTION:

1. Field of the Invention

The present invention relates to electronic cameras that are capable of recording thumbnail pictures, and picture recording apparatuses and picture recording methods.

2. Related Background Art

To speed up reading and displaying recorded picture data in a playing mode, besides recording data files of main pictures of large data amount, some of electronic still cameras, which are one type of electronic cameras, create data files of preview pictures of about horizontal 320 dots×vertical 240 dots, for example, and store the data files of preview pictures that are correlated with the data files of the main pictures. The data files of preview pictures are created by substantially reducing the number of pixels composing the main pictures to match with the number of pixels composing a liquid crystal panel that is a display section of the electronic camera.

Also, the DCF (Design rule for Cameral File system) standard, which is adopted in many of the electronic still cameras, specifies that thumbnail picture data each being composed of 160 dots×120 dots, which is created by further reducing the number of pixels of the main pictures to a level smaller than that of the preview pictures, is incorporated in the data files of the main pictures.

### SUMMARY OF THE INVENTION

In accordance with an embodiment of the present invention, a picture recording apparatus includes a memory that may store a picture data file including first picture data, second picture data having fewer data amount than the first picture data and third picture data having fewer data amount than the second picture data, or a picture data file including the first image data and the third image data, a judging section that judges as to whether or not the picture data file stored in the memory includes the second picture data, and a display control section that has a display section display the second picture data when the judging section judges that the picture data file includes the second picture data, and has the display section display the first picture data or the third picture data included in the picture data file when the judging section judges that the picture data file does not include the second picture data.

In accordance with another embodiment of the present invention, an electronic camera includes a photographing section that photographs a subject image and outputs image data of the subject image, a picture data creating section that creates, based on the picture data outputted from the photographing section, first picture data, second picture data having fewer data amount than the first picture data and third picture data having fewer data amount than the second picture data, a picture data file creating section that creates a picture data file that includes the first picture data, the second picture data and the third picture data created by the picture data creating section, a memory that stores the picture data file created by the picture data file creating section, and a display control section that has a display section display the second picture data included in the picture data file upon displaying the picture data file created by the picture data file creating section.

In accordance with still another embodiment of the present invention, a picture recording apparatus includes a memory that stores first picture data, a judging section that judges as to whether or not the memory stores second picture data having fewer data amount than the first picture data correlated with the first picture data, a picture data creating section that creates the second picture data based on the first picture data when the judging section judges that the memory does not store the second picture data correlated with the first picture data, and a recording control section that correlates the second picture data created by the picture data creating section with the first picture data and stores the second picture data in the memory.

In accordance with yet another embodiment of the present invention, a picture recording apparatus includes a memory that stores first picture data, a judging section that judges as to whether or not the memory stores second picture data having fewer data amount than the first picture data correlated with the first picture data, a display control section that has a display section display the second picture data when the judging section judges that the memory stores the second picture data correlated with the first picture data, and a notification section that makes a notification when the judging section judges that the memory does not store the second picture data correlated with the first picture data.

In accordance with yet another embodiment of the present invention, a picture recording method includes the steps of storing in a memory a picture data file including first picture data, second picture data having fewer data amount than the first picture data and third picture data having fewer data amount than the second picture data, or a picture data file including the first image data and the third image data, judging as to whether or not the picture data file stored in the memory includes the second picture data, having a display section display the second picture data when a determination is made that the picture data file includes the second picture data, and having the display section display the first picture data or the third picture data included in the picture data file when a determination is made that the picture data file does not include the second picture data.

In accordance with another embodiment of the present invention, a picture recording method includes the steps of creating, based on picture data outputted from a photographing section, first picture data, second picture data having fewer data amount than the first picture data and third picture data having fewer data amount than the second picture data, creating a picture data file that includes the first picture data, the second picture data and the third picture data created, storing the created picture data file in a memory, and having a display section display the second picture data included in the picture data file when the picture data file stored in the memory is displayed by the display section.

In accordance with another embodiment of the present invention, a picture recording method includes the steps of storing first picture data in a memory, judging as to whether or not the memory stores second picture data having fewer data amount than the first picture data correlated with the first picture data, creating the second picture data based on the first picture data when it is judged that the memory does not store the second picture data correlated with the first picture data, and correlating the second picture data created with the first picture data and storing the second picture data in the memory.

In accordance with yet another embodiment of the present invention, a picture recording method includes the steps of storing first picture data in a memory, judging as to whether or not the memory stores second picture data having fewer data amount than the first picture data correlated with the first picture data, having a display section display the second picture data when it is judged that the memory stores the second picture data correlated with the first picture data, and giving a notification when it is judges that the memory does not store the second picture data correlated with the first picture data.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 shows a block diagram of a circuit structure of a digital camera in accordance with an embodiment of the present invention.

FIGS. 2A and 2B show structures of a picture data file that is recorded in a flash memory in accordance with the present embodiment.

FIG. 3 shows a flow chart of processing contents in a recording mode in accordance with the embodiment of the present invention.

FIG. 4 shows a flow chart of processing contents in a reproducing mode in accordance with the embodiment of the present invention.

FIG. 5 shows a flow chart of processing contents in a reproducing mode in accordance with another embodiment of the present invention.

FIG. 6 shows a flow chart of processing contents when the power is turned on in accordance with the other embodiment of the present invention.

### DESCRIPTION OF PREFERRED EMBODIMENTS

(First Embodiment)

A digital still camera (hereafter referred to as a “digital camera”) in accordance with an embodiment of the present invention is described with reference to the accompanying drawings.

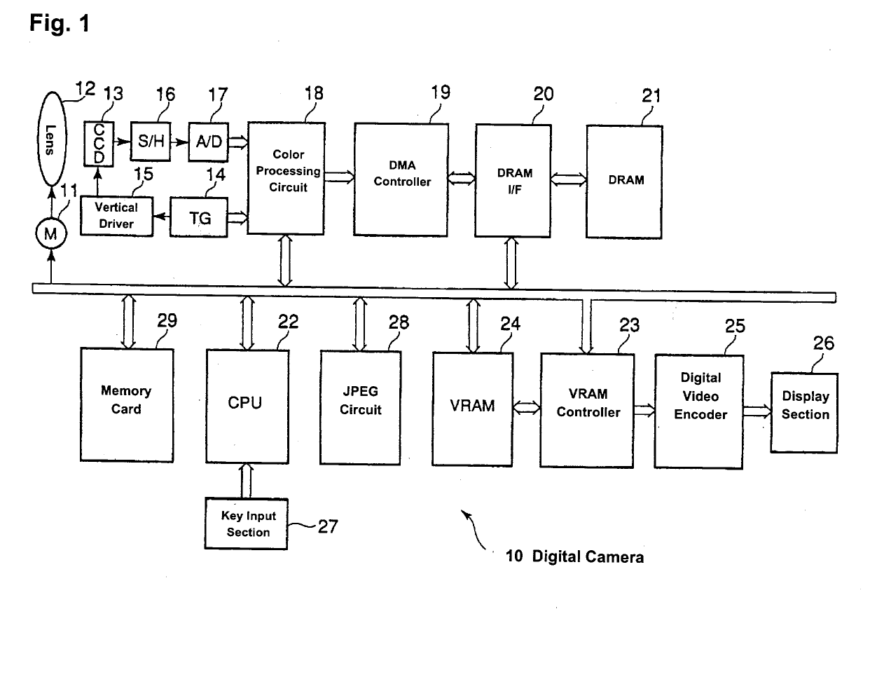

FIG. 1 shows a circuit diagram of the digital camera 10. The digital camera 10 has a recording mode and a playing mode as basic modes, and is capable of switching between the recording mode and the playing mode to set one of them. The digital camera 10 is equipped with a motor 11 that drives a lens optical system including a focus lens module 12 to change its focus position, and a CCD 13 that is a photographing device disposed in the rear of the lens optical system in photographing optical axis. In a monitoring state in the recording mode, the CCD 13 is driven for scanning by a timing generator (TG) 14 and a vertical driver 15, and outputs a photoelectric conversion output for one screen that corresponds to an optical image focused at a predetermined cycle.

The photoelectric conversion output is appropriately adjusted for its gain in the state of analog signal for each of the primary colors of RGB, and then sampled and held by a sample hold circuit (S/H) 16, converted into digital data by an A/D converter 17, and subject to color processings including pixel interpolation processing and γ correction processing by a color processing circuit 18 such that a luminance signal Y and color difference signals Cb and Cr in digital values are created, and outputted to a DMA (Direct Memory Access) controller 19.

The DMA color controller 19 temporarily writes the luminance signal Y and color difference signals Cb and Cr outputted from the color processing circuit 18 in a buffer within the DMA controller 19 using a composite synchronizing signal, memory writing enable signal, and clock signal provided from the color processing circuit 18, and then DMA-transfer the luminance signal Y and color difference signals Cb and Cr signals through a DRAM interface (I/F) 20 to a DRAM 21.

After completion of the DMA-transfer of the luminance signal and color difference signals to the DRAM 21, a CPU 22 reads the luminance signal and color difference signals from the DRAM 21, and writes them through a VRAM controller 23 in a VRAM 24.

A digital video encoder 25 periodically reads the luminance signal and color difference signals from the VRAM 24 through the VRAM controller 23, and generates a video signal based on these signals and output the same to a display section 26.

The display section 26 is composed of, for example, a color liquid crystal display panel with a backlight and a driving circuit for driving the color liquid crystal display panel, and may be disposed on the rear surface side of the digital camera 10. In a recoding mode, the display section 26 functions as an EVF (Electronic View Finder), and performs a display based on video signals from the digital video encoder 25, such that pictures are displayed in real time on the color liquid crystal display panel based on picture information taken from the VRAM controller.

A key input section 27 may be composed of a plurality of keys including a shutter key. When the shutter key is operated at a timing when the user wants to take a still picture photograph while pictures are being displayed in real time as monitor pictures on the display section 26, the shutter key generates a trigger signal.

In response to the trigger signal, the CPU 22 stops the path from the CCD 13 to the DRAM 21 immediately after completion of DMA-transfer of the luminance signal and color difference signals that are being fed from the CCD 13 at this moment for one screen to the DRAM 21, and shifts to a picture recording and storing state.

In the picture recording and storing state, the CPU 22 reads through the DRAM interface 20 the luminance signal and color difference signals for one frame written in the DRAM 21 in units called basic blocks each being composed of vertical 8 pixels×horizontal 8 pixels for each component Y, Cb and Cr, and writes them in a JPEG circuit 28. The JPEG circuit 28 performs a data compression on the signals read using processings such as an ADCT (Adaptive Discrete Cosine Transform), Haffman coding that is one of entropy coding schemes, and the like. The obtained encoded data for one picture is read from the JEPC circuit 28 as a data file, and written in a memory card 29 that contains a flash memory that is a non-volatile memory, which is freely detachably mounted as a recoding medium of the digital camera 10.

Upon completion of the compression processing on the luminance signal and color difference signals for one frame, and writing of the entire compressed data in the memory card 29, the CPU 22 resumes the path from the CCD 13 to the DRAM 21.

At this moment, the CPU 22 correlates a preview picture that is created by thinning out the pixels composing the original picture data and a thumbnail picture that is created by further substantially thinning out the pixels composing the preview picture with the original picture data, and records them together as one picture file data in the memory card 29.

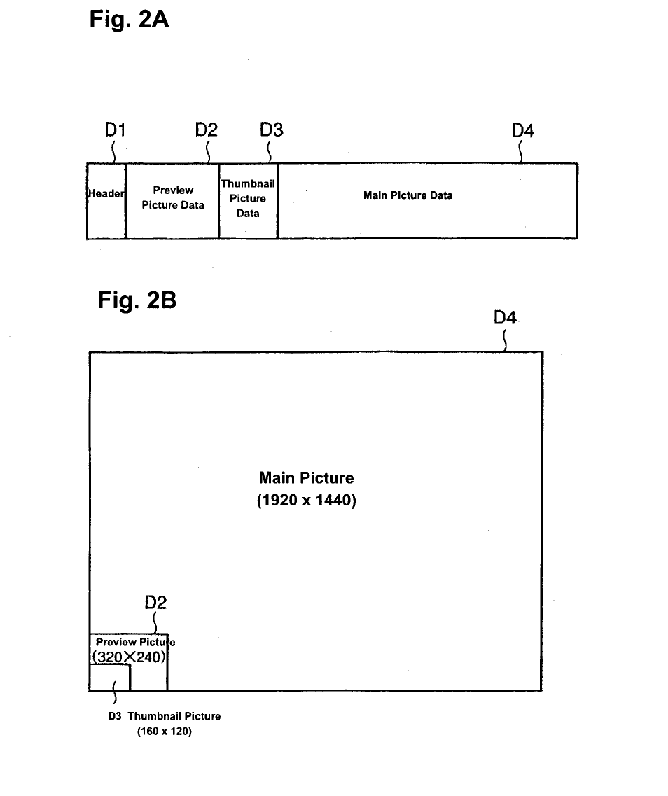

FIG. 2A shows an example of a data format structure of the image data file that is recorded in the memory card 29. For example, the image data file may be composed of a header D1 disposed at the head position of the data file, then preview picture data D2, thumbnail picture data D3, and original picture data D4 in this order, which are formed into one data file in a bundle, added with an extension “.jpg”, for example, according to the DCF standard, and stored as one data file in the memory card 29.

FIG. 2B shows a pixel number structure when the CCD13 has a total pixel number of about little less than three million pixels. In this case, the pixel number structure includes the main picture data (first picture data) D4, and the preview picture data (second picture data) D2 and the thumbnail picture data (third picture data) D3 which are created from the main picture data.

For example, when the main picture data D4 is composed of horizontal 1920 dots×vertical 1440 dots, the main picture data D4 is reduced in size to ⅙ in both of the horizontal and vertical directions, in other words, reduced in pixel number to 1/36 to create the preview picture data D2 composed of horizontal 320 dots×vertical 240 dots.

Then, the preview picture data D2 is further reduced in size to ½ in both of the horizontal and vertical directions, in other words, reduced in pixel number to ¼ to create the thumbnail picture data D3 composed of horizontal 160 dots×vertical 120 dots. As described above, these three picture data D1-D3 are lumped together into a data file, and recorded as one picture data file in the memory card 29.

The key input section 27 may be composed of, in addition to the shutter key, a recording/play mode switching key for switching a recording (REC) mode and playing (PLAY) mode which are basic modes of operation, a “menu” key for displaying various operation menu items, a cross key for designating up, down, right and left directions to select images or various modes and designate selected menu items, a “set” key that may be disposed at a center section of the cross key for designating and setting a content that is currently selected, a power supply key for switching on and off the power supply to the digital camera 10, and the like. Signals generated in response to the key operation are transmitted to the CPU 22.

Next, operations of the embodiment described above are described.

It is noted that processings described below are essentially executed by the CPU 22 based on a program that is stored in advance in a program memory not shown in FIG. 1.

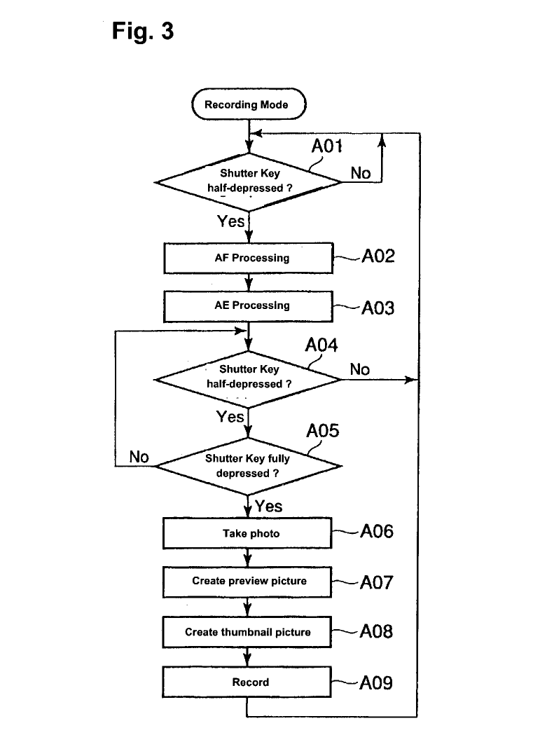

FIG. 3 shows processing contents in a recording mode. At the beginning, the recording mode waits until the shutter key at the key input section 27 is depressed in a half-depressed state (step A01).

In other words, the shutter key detects a key depressing operation in two stage strokes. In the first stage operation, in a so-called half-depressed state, photographing conditions are locked, and in the second stage operation, in a so-called full-depressed state, an actual photographing takes place.

When the shutter key is depressed in the half-depressed state, which is determined in step A01, an automatic focusing (AF) processing is performed to obtain a focus position (step A02), an automatic exposure (AE) processing is performed to obtain an aperture value and shutter speed that provide an appropriate exposure (step A03), and the photographing conditions are locked.

Then, determinations are repeatedly made as to whether the shutter key is still half-depressed (step A04) or whether the shutter key is fully depressed (step A05) to confirm that the shutter key is half-depressed and the process waits for the shutter key to be fully depressed.

If the half-depressed state of the shutter key is released, such state is determined in step A04, and the locked photographing conditions are released, and the process returns to step A01.

When the shutter key is fully depressed, such operation is detected in step A05, and the process shifts to a picture data recording/storing state. More specifically, after main picture data is obtained from this photographing operation (step A06), preview picture data is created from the main picture data (step A07) as indicated above in FIG. 2, thumbnail picture data is further created from the preview picture data (step A08), and the main picture data, the preview picture data and the thumbnail picture data are collected together into a data file which is stored in the memory card 29 (step A09).

A series of the processings for photographing is completed, and the process returns to step A01 in preparation for the next photographing.

In the above description, the thumbnail picture data is created in step A08 using the preview picture data that is created in the processing in step A07. However, the thumbnail picture data may be created from the main picture data.

Also, in the above embodiment, one picture data file including the main picture data, the preview picture data and the thumbnail picture data is created and stored in the memory card 29. However, for example, one picture data file including the main picture data and the thumbnail picture data may be created and stored in the memory card 29; and at the same time, another picture data file including the preview picture data may be independently created, and this picture data file may be correlated with the picture data file including the main picture data and the thumbnail picture data and stored together in the memory card 29.

Alternatively, one picture data file including the main picture data, one picture data file including the preview picture data, and one picture data file including the thumbnail picture data may be independently formed, and these three data sets may be correlated with one another and stored in the memory card 29.

Also, in another embodiment, one picture data file including the main picture data and the preview picture data may be created and stored in the memory card 29; and at the same time, another picture data file including the thumbnail picture data may be independently created, and this picture data file may be correlated with the picture data file including the main picture data and the preview picture data and stored together in the memory card 29.

Furthermore, in another embodiment, one picture data file including the preview picture data and the thumbnail picture data may be created and stored in the memory card 29; and at the same time, another picture data file including the main picture data may be independently created, and this picture data file may be correlated with the picture data file including the preview picture data and the thumbnail picture data and stored together in the memory card 29.

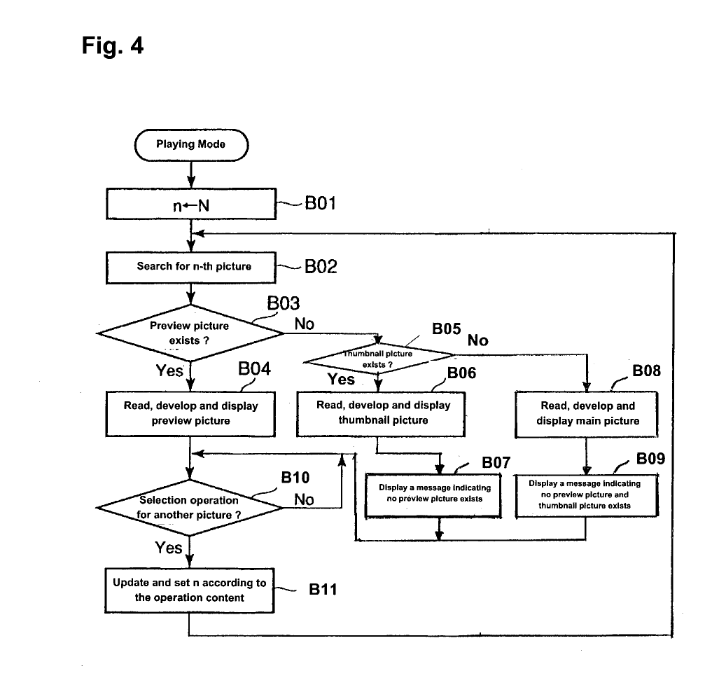

Next, processing contents in a playing mode are described with reference to FIG. 4.

At the beginning of switching from the recording mode to the playing mode, the number N of picture data files that are currently stored in the memory card 29 is inputted in a variable n and the variable is selected (step B01), and the memory card 29 is searched for the n-th picture data file, which is currently the newest picture data (step B02).

A determination is made as to whether the header D1 of the searched picture data file is followed by preview picture data D2 (step B03).

Here, if the preview picture data D2 is present in the picture data file, the preview picture data D2 is read out, developed on the JPEC circuit 28, and outputted for display on the display section 26 (step B04).

If it is determined in step B03 that preview picture data D2 is not present in the picture data file, a determination is made as to whether thumbnail picture data D3 is present in the picture data file (step B05).

If the thumbnail picture data D3 is present in the picture data file, the thumbnail picture data D3 is read out, developed by the JPEC circuit 28, a pixel interpolation is performed on the thumbnail picture data D3 to obtain image data that matches with the display capability of the display section 26, and the obtained image data is outputted for display on the display section 26 (step B06). In addition, a character message or an icon indicating that the picture data file selected and displayed does not include preview picture data may be superposed on the displayed picture and displayed (step B07).

When a determination is made in step B05 that thumbnail picture data D3 is neither present in the picture data, the main picture data that is securely recorded is read out, developed by the JPEG circuit, a pixel interpolation is performed on the main picture data to obtain image data that matches with the display capacity of the display section 26, and the obtained image data is outputted for display on the display section 26 (step B08). In addition, a character message or an icon indicating that the picture data file selected and displayed does not include preview picture data or thumbnail picture data may be superposed on the displayed picture and displayed (step B09).

In this manner, while a certain playing indication corresponding to the presence or absence of the preview picture data D2 and/or the thumbnail picture data D3 is being made, the process waits for an operation to select another picture data file, more specifically, an operation of the cross key or the like in the key input section 27. When a determination is made that any operation is conducted (YES in step B10), the value of the variable n is updated according to the operation content (step B11), and processings from step B02 are executed again, for playing and displaying a picture whose settings are updated.

When a picture data file stored in the memory card 29 does not include preview picture data D2 and/or thumbnail picture data D3, it can be assumed that the picture data file has not been created through photographing and recording by the digital camera 10. Instead, it can be assumed that the memory card 29 was used in a different digital camera that created the picture data file, or the picture data file that has been obtained through photographing by a different digital camera is inputted through an input terminal not shown and recorded on the memory card 29.

In the embodiment described above, when a picture data file that was created by a different digital camera and recorded in a memory card 29 is played, and a determination is made that preview picture data is not included in the picture data file, a determination is made next as to whether thumbnail picture data is included in the picture data file. When it is determined that the thumbnail picture data is included, a play/display operation is performed using the thumbnail picture data, and when it is determined that the thumbnail picture data is not included, a play/display operation is performed using the original picture data. However, when a picture data file stored in the memory card 29 is played, a play/display operation may be performed using the original picture data upon determining that preview picture data is not included in the picture data file.

Also, in the embodiment described above, if it is assumed that all the digital cameras in the world adopt the DCF standard, and picture data files always include thumbnail picture data, the process can shift directly to step B06 after a determination is made in step B03 that preview picture data is not included in a picture data file, and a play/display operation is performed using the thumbnail picture data.

Also, the above embodiment describes a situation where a memory card 29 that stores a picture data file that does not include preview picture data and/or thumbnail picture data because the picture data file was created by a different digital camera is mounted on the digital still camera of the present invention. However, when a memory card 29 is used on different digital cameras, and picture data files are created upon photographing by the different digital cameras, and then the memory card 29 is used on a digital camera of the present invention and picture data files are created upon photographing by the digital camera of the present invention, it is possible that picture data files including only main picture data, picture data files including only main picture data and thumbnail picture data, picture data files including only main picture data and preview picture data, and/or picture data files including main picture data, preview picture data and thumbnail picture data may be mixed and stored in the memory card 29.

Moreover, the digital camera in accordance with the present embodiment may be provided with a picture communication section (including both wireless and wired communications), and the picture communication section may receive picture data files that do not include preview picture data and/or thumbnail picture data transmitted from a different digital camera, and these picture data files may be additionally stored in the memory card 29.

Also, the above embodiment describes a situation where picture data files are selected through key operations by the user. However, the present embodiment may be structured to automatically select picture data files through automatic page feeding, conditional searches and the like.

(Second Embodiment)

A digital camera in accordance with a second embodiment of the present invention is described below with reference to the accompanying drawings.

The digital camera of the second embodiment has a circuit structure that is essentially the same as the circuit structure shown in FIG. 1, and a structure of picture data files to be recorded in a memory card that is a recording medium which is essentially the same as the picture data file structure shown in FIG. 2A. The same components will be assigned the same reference numbers and their description and illustration are omitted.

Also, let us assume that all the digital cameras in the world adopt the DCF standard, and picture data files always include thumbnail picture data.

Operations of the second embodiment will be described.

Processing contents in a recording mode are deemed to be the same as those shown in FIG. 3, and their illustration and description are omitted.

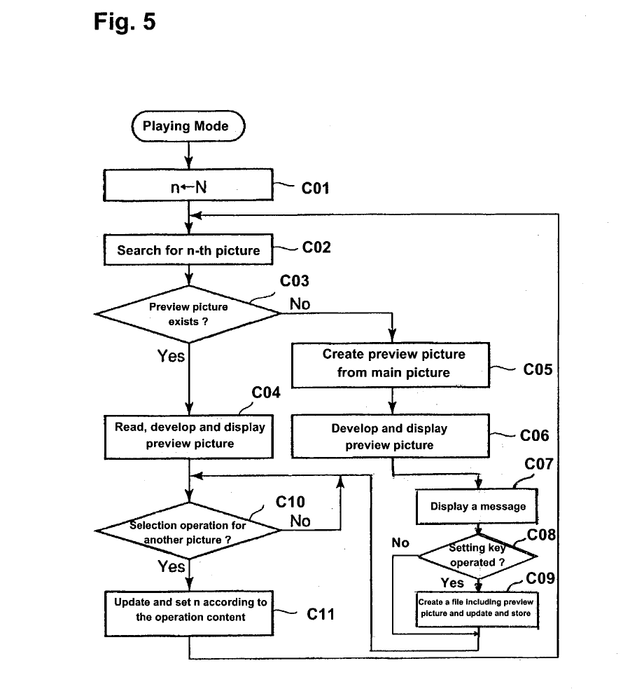

FIG. 5 shows processing contents in a playing mode. As indicated in FIG. 5, at the beginning of switching to the playing mode, the number N of picture data files that are currently stored in a memory card 29 is inputted in a variable n and the variable is selected (step C01), and the memory card 29 is searched for the n-th picture data file, which is currently the newest picture data (step C02).

A determination is made as to whether the header D1 of the searched picture data file is followed by preview picture data D2 (step C03).

Here, if the preview picture data D2 is present in the picture data file, the preview picture data D2 is read out, developed by the JPEC circuit 28, and outputted for display on the display section 26 (step C04).

If it is determined in step C03 that preview picture data D2 is not present in the picture data file, the main picture data is read out and preview picture data is created by thinning out the pixels composing the main picture data (step C05), and the created preview picture data is outputted to be used for display on the display section 26 (step C06).

A character message or an icon indicating that the picture data file selected and displayed does not include preview picture data, and a character message or an icon that asks the user to make a determination as to whether preview picture data is to be embedded in the picture data file may be superposed on the displayed picture and displayed (step C07).

Thereafter, if the user operates the setting key to instruct to embed the preview picture data in the picture data file (YES in step C08), the preview picture data created in step C05 is used to create a new picture data file that includes the main picture data, preview picture data and thumbnail picture data, as indicated in FIG. 2A, and the original picture data file stored in the memory card 29 is updated and replaced with the new picture data file (step C09)

Then, when the preview picture data D2 may be created depending on the requirement, and while the preview picture data D2 is being displayed on the display section 26, the process waits for an operation to select another picture data file, more specifically, an operation of the cross key or the like in the key input section 27. When a determination is made that any operation is conducted (YES in step C10), the value of the variable n is updated and set according to the operation content (step C11), and processings from step C02 are executed again, for playing and displaying a picture whose settings are updated.

In the embodiment described above, it is assumed that picture data files always include thumbnail picture data. However, picture data files do not necessarily include thumbnail picture data.

Also, in the embodiment described above, a message for confirming whether the picture data file is to be updated and stored is displayed by the display section 26; and only when the user indicates an execution of updating of recording the picture data file, the picture data file is updated and recorded. However, when preview picture data is not included in the picture data file, the picture data file may be automatically (i.e., forcefully) updated and recorded. When the picture data file is automatically updated and recorded, the main picture data may be read out, preview picture data may be created by thinning out the main picture data, a new picture data file including the preview picture data may be created, and the picture data file stored in the memory card 29 may be updated with the new picture data file including the preview picture data. Then, the preview picture data file in the new picture data file may be read out, the preview picture data may be developed by the JPEG circuit 29, and then the preview picture data is outputted for display by the display section 26.

Further, the above embodiment describes a situation where only the picture data file including the main picture data and thumbnail picture data, and the picture data file including the main picture data, preview picture data and thumbnail picture data are mixed and recorded in the same memory card 29. However, the present invention is also applicable to a situation where picture data files including only main picture data, picture data files including only main picture data and thumbnail picture data, picture data files including only main picture data and preview picture data, and/or picture data files including main picture data, preview picture data and thumbnail picture data may be mixed and stored in the same memory card 29.

Also, the above embodiment describes a situation where picture data files are selected through key operations by the user. However, the present embodiment may be structured to automatically select picture data files through automatic page feeding, conditional searches and the like.

Moreover, in the embodiment described above, at the time when each of the picture data files is selected for playing (displaying), a preview picture data corresponding to the selected picture data file is created and the picture data file is updated and recorded. However, all of the picture data files stored in the memory card 29 may be successively selected once when the power for the digital camera 10 is turned on, when the mode is switched from the recording mode to the playing mode, when the user instructs an execution of the operation, at predetermined time intervals, or at predetermined times, and the aforementioned updating and recording may be conducted at once for each of the picture data files as necessary.

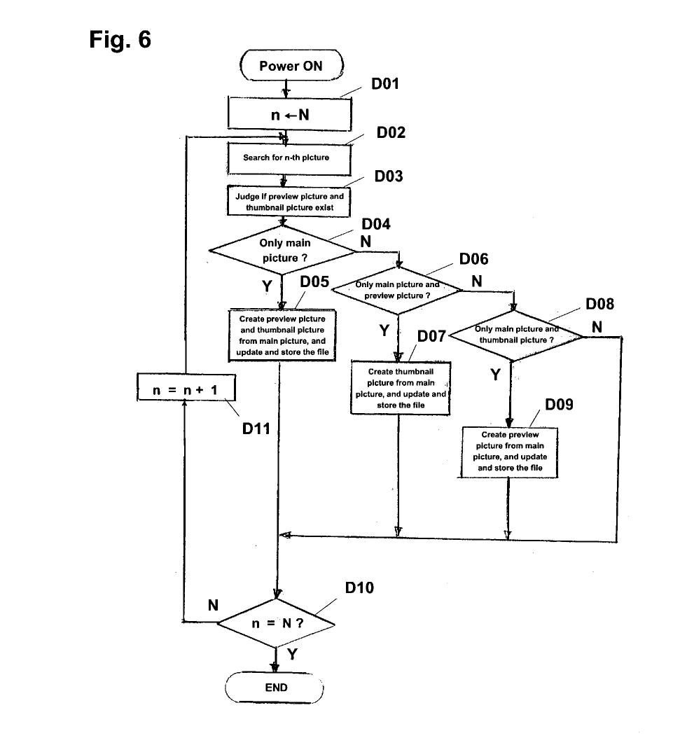

FIG. 6 shows processing contents of the updating and recording process that is conducted for all of the picture data files stored in the memory card 29 at the time the power of the digital camera 10 is turned on.

The operation indicated in FIG. 6 will be described, assuming that a picture data file that includes either preview picture data or thumbnail picture data, or includes neither of them is present.

First, when the power of the digital camera is turned on by an operation of the power supply key by the user, the number N of picture data files that are currently stored in the memory card 29 is inputted in a variable n and the variable is selected (step D01), and the memory card 29 is searched for the n-th picture data file, which is currently the newest picture data (step D02).

Next, a determination is made as to whether the searched picture data file includes preview picture data and thumbnail picture data (step D03)

As a result of the determination made in step D03, if it is determined that the searched picture data file includes only the main picture data (YES in step D04), preview picture data and thumbnail picture data are created from the main picture data, then a new picture data file including the main picture data, preview picture data and thumbnail picture data is created, and the original picture data file in the memory card 29 is replaced with the new picture data file and stored therein (step D05).

Also, as a result of the determination made in step D03, if it is determined that the searched picture data file includes only the main picture data and preview picture data (YES in step D06), thumbnail picture data is created from the main picture data, then a new picture data file including the main picture data, preview picture data and thumbnail picture data is created, and the original picture data file in the memory card 29 is replaced with the new picture data file and stored therein (step D07).

Also, as a result of the determination made in step D03, if it is determined that the searched picture data file includes only the main picture data and thumbnail picture data (YES in step D08), preview picture data is created from the main picture data, then a new picture data file including the main picture data, preview picture data and thumbnail picture data is created, and the original picture data file in the memory card 29 is replaced with the new picture data file and stored therein (step D09).

After the file updating processing in either step D05, D07 or D09 is completed, or as a result of the determination made in step D03, if a determination is made that the searched picture data file includes all the main picture data, preview picture data and thumbnail picture data (NO in step D08), the process proceeds to step D10, where a determination is made as to whether the aforementioned value n matches with the number N of the picture data files stored in the memory card 29, to thereby judge whether the updating processing has been completed for all of the picture data files stored in the memory card 29.

If it is determined that the value n equals to the number N (n=N), the updating processing is completed. When it is determined that the value n is not equal to the number N (n≠N), the value of the variable n is updated and set (step D11), and the processings from step D02 are executed again, and the processings in step D02 to D11 are repeated until the updating processing for all of the picture data files stored in the memory card 29 is completed.

It is noted that, in the above description, thumbnail picture data is created from main picture data in step D05 or D07. However, thumbnail picture data may be created from preview picture data.

Also, in the first and second embodiments described above, the present invention is applied to digital cameras (electronic still cameras). However, the present invention is not limited to these embodiments, but is also readily applicable to portable telephone terminals with cameras, PDAs (Personal Digital Assistants) with cameras, personal computers with cameras, moving picture cameras. In other words, the present invention is applicable to any apparatuses equipped with a camera function.

Also, in the first and second embodiments described above, the present invention is applied to apparatuses equipped with a camera function. However, the present invention is not limited to these embodiments, but is also readily applicable to portable telephone terminals, PDAs (Personal Digital Assistants) and personal computers. In other words, the present invention is applicable to any apparatuses equipped with a memory that is capable of storing picture data files.

In addition, the present invention is not limited to the first and second embodiments described above, and many modifications can be made and implemented within the scope of the subject matter of the invention.

Furthermore, the first and second embodiments described above include a variety of inventions in different stages, and a variety of inventions can be derived by different combinations of a plurality of disclosed components. For example, even when some of the components may be deleted from the entire components described in the embodiments, at least one of the problems to be solved by the present invention can may be solved, and at least one of the effects described in the present specification can be obtained. In such a case, the present invention can also be derived from the structure without the deleted components.

What is claimed is:

1. A picture recording apparatus comprising:
a memory that stores at least a picture data file including first picture data, second picture data having fewer data amount than the first picture data and third picture data having fewer data amount than the second picture data or a picture data file including the first picture data and the third picture data;
a judging section that judges as to whether the picture data file stored in the memory includes the second picture data; and
a display control section that has a display section display the second picture data when the judging section judges that the picture data file includes the second picture data, and has the display section display the first picture data or the third picture data included in the picture data file when the judging section judges that the picture data file does not include the second picture data.

2. A picture recording apparatus according to claim 1, wherein the memory stores a plurality of picture data files, and further comprising a selection section that selects one of the plurality of picture data files stored in the memory, wherein the judging section determines whether the picture data file selected by the selection section includes the second picture data.

3. A picture recording apparatus according to claim 1, further comprising a notification section that makes a notification when the judging section determines that the picture data file does not include the second picture data.

4. A picture recording apparatus according to claim 1, wherein
the memory stores at least one of a picture data file including the first picture data, the second picture data and the third picture data, a picture data file including the first picture data and the third picture data and a picture data file including the first picture data,
the judging section determines, upon determining that one of the picture data files does not include the second picture data, whether the one of the picture data files includes the third picture data, and
the display control section has the display section display the third picture data when the judging section determines that the one of the picture data files includes the third picture data, and has the display section display the first picture data included in the one of the picture data files when the judging section determines that the one of the picture data files does not include the third picture data.

5. A picture recording apparatus according to claim 4, further comprising a notification section that makes a first notification when the judging section determines that the picture data file does not include the second picture data, and makes a second notification different from the first notification when the judging section determines that the picture data file does not include the third picture data.

6. A picture recording apparatus according to claim 1, further comprising
a photographing section that photographs a subject image and outputs picture data of the subject image,
a picture data creating section that creates, based on the picture data outputted from the photographing section, first picture data, second picture data having fewer data amount than the first picture data and third picture data having fewer data amount than the second picture data, and
a picture data file creating section that creates a picture data file including the first picture data, the second picture data and the third picture data created by the picture data creating section,
wherein the memory stores the picture data file created by the picture data file creating section.

7. A picture recording apparatus according to claim 1, wherein the memory is an independent memory that can be installed on and removed from the picture recording apparatus.

8. An electronic camera comprising:
a photographing section that photographs a subject image and outputs image data of the subject image;
a picture data creating section that creates, based on the picture data outputted from the photographing section, first picture data, second picture data having fewer data amount than the first picture data and third picture data having fewer data amount than the second picture data;
a picture data file creating section that creates a picture data file that includes the first picture data, the second picture data and the third picture data created by the picture data creating section;
a memory that stores the picture data file created by the picture data file creating section; and
a display control section that has a display section display the second picture data included in the picture. data file upon displaying the picture data file stored in the memory.

9. An electronic camera according to claim 8, wherein the memory stores a plurality of picture data files containing a picture data file including the first picture data and the third picture data, and further comprising a selection section that selects one of the plurality of picture data files stored in the memory, and a judging section that judges whether the one of the plurality picture data files selected by the selection section includes the second picture data,
wherein the display control section has the display section display the second picture data when the judging section judges that the one of the plurality of picture data files includes the second picture data, and has the display section display the first picture data or the third picture data included in the one of the plurality of picture data files when the judging section judges that the one of the plurality of picture data files does not include the second picture data.

10. A picture recording apparatus comprising:
a memory that stores first picture data;
a judging section that judges whether the memory stores second picture data having fewer data amount than the first picture data correlated with the first picture data;
a picture data creating section that creates the second picture data based on the first picture data when the judging section judges that the memory does not store the second picture data correlated with the first picture data; and
a recording control section that correlates the second picture data created by the picture data creating section with the first picture data and stores the second picture data in the memory.

11. A picture recording apparatus according to claim 10, further comprising a display control section that has a display section display the second picture data when the judging section judges that the memory stores the second picture data correlated with the first picture data, and has the display section display the first picture data when the judging section judges that the memory does not store the second picture data.

12. A picture recording apparatus according to claim 10, wherein the memory stores a plurality of first picture data sets, and further comprising a selection section that selects one of the plurality of first picture data sets stored in the memory, wherein the judging section judges whether the memory stores the second picture data correlated with the one of the first picture data sets selected by the selection section.

13. A picture recording apparatus according to claim 10, further comprising an instruction section that instructs to record the second picture data, wherein, when the instruction section instructs to record the second picture data, the recording control section correlates the second picture data created by the picture data creating section with the first picture data and stores the second picture data in the memory.

14. A picture recording apparatus according to claim 10, further comprising a notification section that makes a notification when the judging section judges that the memory does not store the second picture data correlated with the first picture data sets.

15. A picture recording apparatus according to claim 10, wherein
the memory stores a picture data file including the first picture data,
the judging section judges whether the picture data file stored in the memory includes the second picture data, and
when the judging section judges that the picture data file does not include the second picture data, the picture data creating section creates the second picture data based on the first picture data,
and further comprising a picture data file creating section that creates a picture data file including the second picture data created by the picture data creating section and the first picture data, wherein the recording control section stores the picture data file created by the picture data file creating section in the memory.

16. A picture recording apparatus according to claim 10, wherein
the judging section judges whether the memory stores third picture data having fewer data amount than the second picture data correlated with the first picture data,
when the judging section judges that the memory does not store the third picture data correlated with the first picture data, the picture data creating section creates the third picture data based on the first picture data or the second picture data, and
the recording control section correlates the third picture data created by the picture data creating section with the first picture data and stores the third picture data in the memory.

17. A picture recording apparatus according to claim 16, wherein
the memory stores a picture data file including the first picture data,
the judging section judges whether the picture data file stored in the memory includes the second picture data or the third picture data,
when the judging section judges that the picture data file does not include the second picture data and the third picture data, the picture data creating section creates the second picture data and the third picture data based on the first picture data,
when the judging section judges that the picture data file does not include the third picture data, the picture data creating section creates the third picture data based on the first picture data or the second picture data, and
when the judging section judges that the picture data file does not include the second picture data, the picture data creating section creates the second picture data based on the first picture data,
and further comprising a picture data file creating section that creates a picture data file including the first picture data, and the second picture data and/or the third picture data, wherein the recording control section stores the picture data file created by the picture data file creating section in the memory.

18. A picture recording apparatus comprising:
a memory that stores first picture data;
a judging section that judges as to whether the memory stores second picture data having fewer data amount than the first picture data correlated with the first picture data;
a display control section that has a display section display the second picture data when the judging section judges that the memory stores the second picture data correlated with the first picture data; and
a notification section that makes a notification when the judging section judges that the memory does not store the second picture data correlated with the first picture data.

19. A picture recording apparatus according to claim 18, wherein the display control section has the display section display the first picture data when the judging section judges that the memory does not store the second picture data correlated with the first picture data.

20. A picture recording method comprising the steps of:
storing in a memory a picture data file including first picture data, second picture data having fewer data amount than the first picture data and third picture data having fewer data amount than the second picture data, or a picture data file including the first image data and the third image data;
judging whether the picture data file stored in the memory includes the second picture data;
having a display section display the second picture data when a determination is made that the picture data file includes the second picture data; and
having the display section display the first picture data or the third picture data included in the picture data file when a determination is made that the picture data file does not include the second picture data.

21. A picture recording method comprising the steps of:
creating, based on picture data outputted from a photographing section, first picture data, second picture data having fewer data amount than the first picture data and third picture data having fewer data amount than the second picture data;
creating a picture data file that includes the first picture data, the second picture data and the third picture data created;
storing the created picture data file in a memory; and
having a display section display the second picture data included in the picture data file when the display section displays the picture data file stored in the memory.

22. A picture recording method comprising the steps of:
storing first picture data in a memory;
judging whether the memory stores second picture data having fewer data amount than the first picture data correlated with the first picture data;
creating the second picture data based on the first picture data when it is judged that the memory does not store the second picture data correlated with the first picture data; and
correlating the second picture data created with the first picture data and storing the second picture data in the memory.

23. A picture recording method comprising the steps of
storing first picture data in a memory;
judging whether the memory stores second picture data having fewer data amount than the first picture data correlated with the first picture data;
having a display section display the second picture data when it is judged that the memory stores the second picture data correlated with the first picture data; and
giving a notification when it is judged that the memory does not store the second picture data correlated with the first picture data.
